(19) United States
(12) Patent Application Publication
(10) Pub. No.: US 2025/0068137 A1
(43) Pub. Date: Feb. 27, 2025

(54) CONTROL DEVICE

(71) Applicant: FANUC CORPORATION, Minamitsuru-gun, Yamanashi (JP)

(72) Inventors: Takuya SAKAGAMI, Yamanashi (JP); Shouhei MIYASHTA, Yamanashi (JP); Kun LIU, Yamanashi (JP)

(21) Appl. No.: 18/725,466

(22) PCT Filed: Mar. 30, 2022
(86) PCT No.: PCT/JP2022/015845

§ 371 Date: Jun. 28, 2024

(51) Int. Cl. G05B 19/05

(52) U.S. Cl. CPC G05B 19/054

(57) ABSTRACT

Provided is a control device which, in order to easily confirm and change the state of variables spanning a namespace, comprises: a memory; a storage unit that manages sequence programs executed for each namespace and variable definitions that are used in the sequence programs; a reference information generation unit that generates reference information for any address in the memory and any variable definition registered in the storage unit; and a group management unit that registers the reference information in groups and manages the registered groups, wherein an arbitrary group is selected from the group management unit, an address is acquired from the memory and a variable definition is acquired from the storage unit on the basis of reference information for the variable definitions and addresses registered in the group, and notification is provided to a display unit, whereby variables can be diagnosed across any address and namespace.

### TECHNICAL FIELD

The present invention relates to a control apparatus for managing variables and signals in a plurality of namespaces by group.

### BACKGROUND ART

In a PLC, particular functions and variables of a sequence program are associated and defined, for example, for each system. Further, in the case of performing programming by combining program organization units (POUs) standardized by IEC61131-3, variables are defined for each POU (see, for example, Patent Document 1). Specifically, from the point of view of variable definition, system or POU is included in the concept of namespace where variables are defined, and variable management for each system or POU is equivalent to variable management for each namespace. Thus, in variable management in namespaces, settings are made so that variables are managed for each namespace, and it is possible to uniformly make settings for variables belonging to the same namespace and, for each namespace, collectively check or diagnose the variables belonging to the same namespace for each namespace on a screen. On the other hand, it is not possible to check variables set in different namespaces from the namespaces. FIG. 8 is a diagram showing Group 1, in which an aspect of the case where variables are set for each namespace is shown and illustrated. As shown in FIG. 8, when a user wants to check or diagnose variables set in each of a plurality of namespaces A, B, and C, the user has to, for each namespace, individually check or diagnose variables set for the namespace. Citation List

### PATENT DOCUMENT

Patent Document 1: Japanese Unexamined Patent Application, Publication No. 2005-301520

### DISCLOSURE OF THE INVENTION

### Problems to be Solved by the Invention

As described before, in a PLC, particular functions and variables of a sequence program are associated and defined, for example, for each system. Further, in the case of performing programming by combining program organization units (POUs) standardized by IEC61131-3, variables are defined for each POU. Therefore, although it is necessary to uniquely define each variable name in a namespace, the user does not have to be aware of duplication with variable names defined in other namespaces. Therefore, the function is useful at the time of dividing a program into modules to develop each module. In the case where variables are defined for each of different systems or different POUs, however, if it becomes necessary to, for example, at the time of performing debugging to check or diagnose a function of a program or when a problem occurs in a function at the time of executing a program, check or diagnose states of variables related to the function, it is necessary to, for each namespace, check or diagnose variables set in the namespace by switching among displays as shown in FIG. 8, and the operation is very complicated.

Therefore, for a program created over a plurality of namespaces, it is desired to make it possible to collectively check or diagnose states of arbitrary variables defined in the program, across a plurality of namespaces.

The present invention has been made in view of the above-described circumstances, and an object thereof is to provide a control apparatus making it possible to, for a program created over a plurality of namespaces, collectively check or diagnose states of arbitrary variables across the plurality of namespaces at the same time, by providing a mechanism for managing pieces of information for referring to variable definitions by group, over the plurality of namespaces. Means for Solving the Problems

An aspect of the present disclosure is a control apparatus communicably connected to a PLC apparatus, the PLC apparatus including: a memory unit in which addresses available on a PLC and data of current values at the addresses are recorded, and a storage unit that manages a sequence program to be executed for each of namespaces and pieces of variable definition information related to variables defined for the addresses recorded in the memory unit, the pieces of variable definition information being for use in the sequence program for each of the namespaces, and the control apparatus including a control unit and an input unit. The control unit includes: a group editing request acceptance unit configured to receive, via the input unit, an input of arbitrary addresses recorded in the memory unit or an input of arbitrary variables registered with the storage unit for each of the namespaces, the group editing request acceptance unit being configured to accept a request to create a group or a request to edit a group; a reference information generation unit configured to generate pieces of reference information indicating where in the memory unit or the storage unit the addresses or the variables accepted by the group editing request acceptance unit are recorded; a group management unit configured to create a new group based on members including the pieces of reference information in a case of accepting the request to create a group by the group editing request acceptance unit, and, to additionally register members including the pieces of reference information into the group in a case of accepting the request to edit a group by the group editing request acceptance unit; and a query request acceptance unit configured to accept, via the input unit, a request to query an arbitrary group managed by the group management unit. The group management unit acquires, in response to the query request accepted by the query request acceptance unit, addresses and current values from the memory unit, and pieces of variable definition information from the storage unit, based on pieces of reference information registered in the group requested to be queried, and provides the addresses, the current values, and the pieces of variable definition information as queried information about members included in the group. Effects of the Invention

According to the present invention, it is possible to, for a program created over a plurality of namespaces, collectively check or diagnose states of arbitrary variables across the plurality of namespaces at the same time, by providing a mechanism for managing pieces of information for referring to variable definitions by group, over the plurality of namespaces.

### BRIEF DESCRIPTION OF THE DRAWINGS

FIG. 1 is an overview diagram showing functional blocks of a control apparatus according to one embodiment;

FIG. 2 is an overview diagram showing an example of reference information indicating where addresses or variables are recorded, over namespaces in the control apparatus according to the one embodiment;

FIG. 3 is an overview diagram showing an example of generating pieces of reference information for variables satisfying a specified condition in the control apparatus according to the one embodiment;

FIG. 4A is a conceptual diagram showing an aspect of checking states of variables by group in the control apparatus according to the one embodiment;

FIG. 4B is an overview diagram showing an example of display content showing states of variables by group in the control apparatus according to the one embodiment;

FIG. 5 is an overview diagram showing an example of setting of whether viewing and editing of members included in each group are allowed or not, and of display order of the members in the control apparatus according to the one embodiment;

FIG. 6 is a diagram showing an example of subgroups included in a group in the control apparatus according to the one embodiment;

FIG. 7A is a flowchart showing an operation of the control apparatus according to the one embodiment;

FIG. 7B is a flowchart showing an operation of the control apparatus according to the one embodiment; and

FIG. 8 is a diagram showing an aspect of a conventional technique in which variables are set for each namespace.

### PREFERRED MODE FOR CARRYING OUT THE INVENTION

An embodiment of the present invention will be described in detail below with reference to drawings. First, the configuration of a control apparatus according to the embodiment of the present invention will be described.

### 1. Overall Configuration

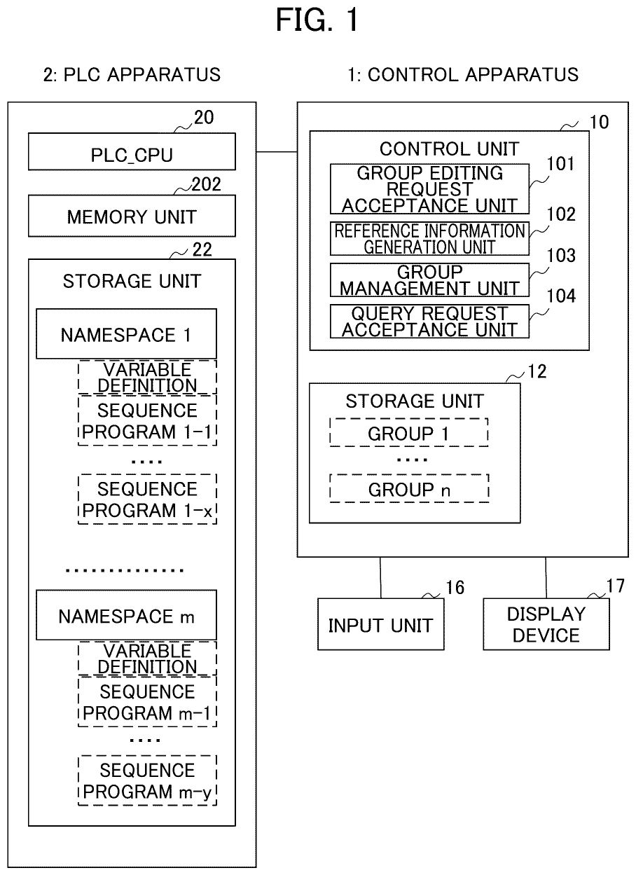

FIG. 1 shows a configuration example of the control apparatus according to the present embodiment.

As shown in FIG. 1, a control apparatus 1 is communicably connected to a PLC apparatus 2. The control apparatus 1 and the PLC apparatus 2 may be mutually directly connected via connection interfaces not shown.

As shown in FIG. 1, the PLC apparatus 2 is provided with a PLC_CPU 20, a memory unit 202, and a storage unit 22. In the memory unit 202, at addresses available on a PLC, current values of the addresses are recorded. For example, values of variables used in a sequence program are stored at addresses corresponding to the variables, respectively. The storage unit 22 stores variable definitions related to the variables used in the sequence program (also referred to as “local variables”). As described before, the variable definitions are set for each namespace. For example, for each system, variable names defined in the sequence program and addresses where values of the variables are recorded are associated and defined. In the case of POUs, variables defined in the sequence program (local variables) are similarly defined, for example, for each POU. In the case of POUs, though addresses are assigned to variables related to external input/output (also referred to as “global variables”), it is not necessary to associate and define variable names and addresses for memory assignment of variables used in a program (local variables) because the memory assignment is automatically processed. Description will be made below on the case where the present invention is applied to system names as namespaces unless otherwise stated, and the same goes for the case of applying the present invention to POU names. Further, the present invention is applicable not only to system names and POU names but also to arbitrary namespaces.

The PLC_CPU 20 is a processor for executing a sequence program and executing control for performing various kinds of control, and control for performing arithmetic processing, signal input/output processing, and the like according to the sequence program. For example, the PLC_CPU 20 reads a sequence program stored in a ROM via a bus and performs sequence control according to the sequence program. Further, the PLC CPU 20 is provided with an input/output interface unit (not shown) for input/output with the control apparatus 1 described later, and can, in response to a request from the control apparatus 1 to access the memory unit 202 and the storage unit 22, respond, for example, with pieces of variable definition information recorded in the storage unit 22 and current values recorded at addresses corresponding to the variables, which are recorded in the memory unit 202.

As shown in FIG. 1, the control apparatus 1 is provided with a control unit 10, a storage unit 12, an input unit 16, and a display device 17. The control unit 10 is, for example, a processor well known to one skilled in the art, which is configured to be mutually communicable with a ROM, a RAM, a CMOS memory, and the like via a bus.

The control unit 10 is configured to, by reading a program for executing functions specific to the invention of the present application, for example, from the storage unit 12 storing the program and executing the program using data that is temporarily required to execute the program, the data being stored in a main memory (not shown) such as the RAM, realize functions of a group editing request acceptance unit 101, a reference information generation unit 102, a group management unit 103, and a query request acceptance unit 104 as shown in FIG. 1. These functional units will be described later.

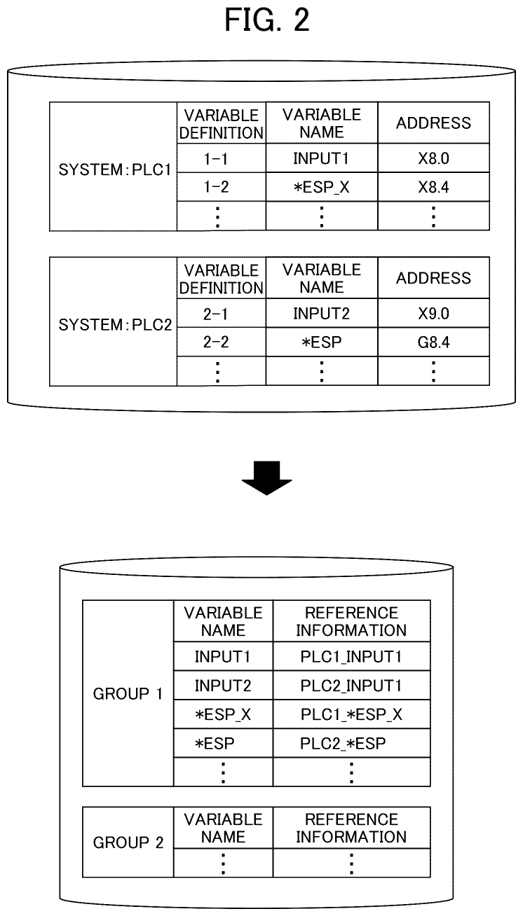

In the storage unit 12, reference information corresponding to each variable names included in each group, which is generated by the reference information generation unit 102, is stored as described later. FIG. 2 is a diagram showing an example of pieces of reference information indicating where in the memory unit 202 or the storage unit 22 addresses or variable definitions are recorded.

As shown in FIG. 2, variable definitions are made for each system. For example, for System PLC1, a variable definition 1-1 defining a variable name INPUT1 and an address X8.0 and a variable definition 1-2 defining a variable name *ESP X and an address X8.4 are defined. Further, for System PLC2, which is another system, a variable definition 2-1 defining a variable name INPUT2 and an address X9.0 and a variable definition 2-2 defining a variable name *ESP and an address G8.4 are defined. In the case of checking the variable name INPUT1 and the variable name *ESP X in System PLC1 in the above situation, a user himself has to refer to variable definitions in System PLC1 and check values stored in the variables via corresponding addresses; and, in the case of checking the variable name INPUT2 and the variable name *ESP in System PLC2, the user has to refer to variable definitions in System PLC2 and check values stored in the variables via corresponding addresses.

In order to solve the above problem, in the present invention, the variable name INPUT1 and the variable name *ESP X in System PLC1 and the variable name INPUT2 and the variable name *ESP in System PLC2 are defined as one group (Group 1) and managed as shown in FIG. 2. Specifically, in a group (Group 1), each variable name and reference information indicating in which system the variable name is defined are associated and defined. For example, since the variable name INPUT1 is defined in System PLC1, for example, PLC1_INPUT1 is defined as reference information. Similarly, since the variable name INPUT2 is defined in System PLC2, for example, PLC2 INPUT2 is defined as reference information. By doing so, variables set in different systems are managed as one group, and, thereby, the user can collectively check or diagnose the variables included in the group at the same time as described later.

The input unit 16 is configured with an input device, for example, a keyboard, a mouse, a touch panel, or a microphone, and, for example, input of information to the control apparatus 1 from the user is accepted via the input unit 16. The display device 17 is configured with a display device, for example, an LCD (liquid crystal display), or CRT (cathode ray tube), organic EL, or LED (light emitting diode) display, and, for example, displays queried information about members included in groups that the user has requested to query as described later.

Next, the functional units of the control apparatus 1 will be described. The group editing request acceptance unit 101 accepts a group creation or editing request from the user via the input unit 16. Specifically, the group editing request acceptance unit 101 accepts arbitrary addresses recorded in the memory unit 202 or arbitrary variable names registered with the storage unit 22 for each namespace and accepts a request to newly create a group, from the user via the input unit 16. The group editing request acceptance unit 101 may be adapted to accept an arbitrary condition from the user via the input unit 16 as described later. In this case, the reference information generation unit 102 can generate pieces of reference information for variables satisfying the condition specified via the input unit 16 and generate a group satisfying the condition based on the generated pieces of reference information as described later. Further, the group editing request acceptance unit 101 can accept input of an existing group name and accept a request to edit the group, from the user via the input unit 16.

When accepting the arbitrary addresses recorded in the memory unit 202 or the arbitrary variable names registered with the storage unit 22 for each namespace, which have been accepted by the group editing request acceptance unit 101, the reference information generation unit 102 generates pieces of reference information indicating where in the memory unit 202 or the storage unit 22 the addresses or the variables are recorded. Specifically, as described before, the reference information generation unit 102 associates and defines each variable name and reference information indicating in which system the variable name is defined, for example, as shown in FIG. 2. As shown in FIG. 2, for example, since the variable name INPUT1 is defined in System PLC1, for example, PLC1 INPUT1 is defined as reference information. Similarly, since the variable name INPUT2 is defined in System PLC2, for example, PLC2 INPUT2 is defined as reference information.

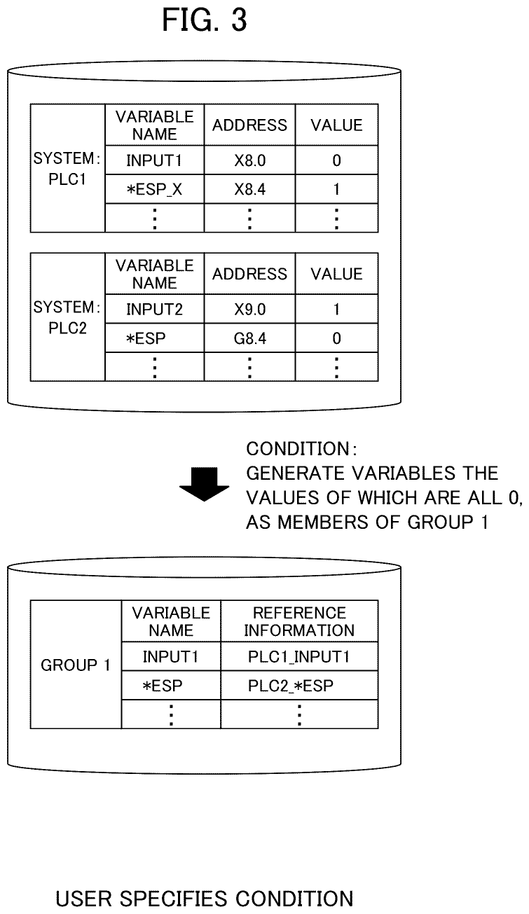

Further, the reference information generation unit 102 may generate pieces of reference information for variables satisfying a condition specified via the input unit 16. FIG. 3 is an overview diagram showing an example of generating pieces of reference information for variables satisfying a specified condition. As shown in FIG. 3, for example, all such variable names that values are 0 are searched for in System PLC1 and System PLC2, and, for each of all the variable names satisfying the condition, reference information indicating in which system the variable name is defined is created. In the example shown in FIG. 3, since the variable name INPUT1 belonging to System PLC1 and the variable name *ESP belonging to System PLC2 satisfy the condition, the reference information generation unit 102 generates pieces of reference information for the variable name INPUT1 belonging to System PLC1 and the variable name *ESP belonging to System PLC2, respectively. For example, for specification of systems to which variables belong, and an arbitrary condition to be satisfied by variables belonging to each system, the reference information generation unit 102 can generate pieces of reference information for variable names satisfying the condition. Thereby, when desiring to collectively check or diagnose variables satisfying a certain condition, the user can automatically generate pieces of reference information for the variables satisfying the condition simply by inputting the condition. As a result, the group management unit 103 generates a group including the variables satisfying the condition as described later and it is possible to collectively check or diagnose states of the variables satisfying the condition.

When a group creation request is accepted by the group editing request acceptance unit 101, the group management unit 103 creates a new group based on members that include pieces of reference information generated by the reference information generation unit 102 as described before. Further, when an editing request to add a variable name to an existing group is accepted by the group editing request acceptance unit 101, the group management unit 103 additionally registers reference information corresponding to the variable name, which has been generated by the reference information generation unit 102, with the group. Further, when an editing request to delete a specified variable name from an existing group is accepted by the group editing request acceptance unit 101, the group management unit 103 deletes reference information corresponding to the variable name from the group.

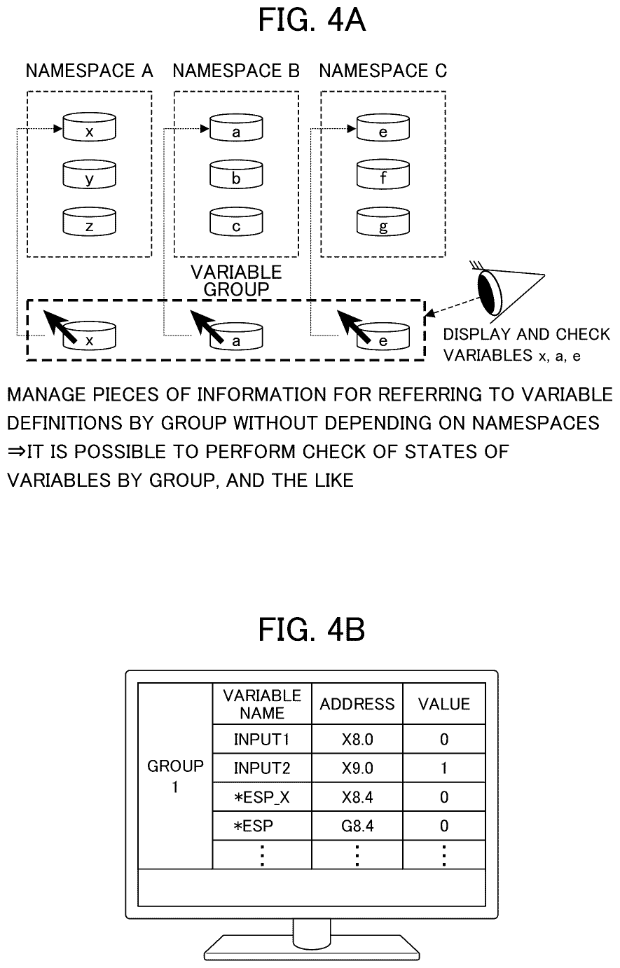

Further, in response to a group query request accepted by the query request acceptance unit 104 described later, the group management unit 103 provides queried information about members included in the group requested to be queried, by acquiring pieces of variable definition information from the storage unit 22 based on pieces of reference information registered in the group requested to be queried, and acquiring current values stored at addresses from the memory unit 202. Specifically, for example, by providing the queried information about the members included in the group requested to be queried, for the display device 17, the display device 17 displays the queried information about the members. Thereby, it is possible to, for a program created over a plurality of namespaces, collectively check or diagnose states of arbitrary variables across the plurality of namespaces at the same time, by providing a mechanism for performing management by group. FIG. 4A is a conceptual diagram showing an aspect of checking states of variables by group. As shown in FIG. 4A, by generating a group that includes a variable x included in a namespace A, a variable y included in a namespace B, and a variable e included in a namespace C, the user can collectively check the variables x, a, and e at the same time. FIG. 4B is an overview diagram showing an example of display content showing states of variables by group. Group 1 shown in FIG. 4B exemplifies Group 1 described with reference to FIG. 2. As shown in FIG. 4B, by querying Group 1, it is possible to display at the same time, for example, addresses of the variable name INPUT1 and the variable name *ESP X in System PLC1 and current values stored at the addresses, and addresses of the variable name INPUT2 and the variable name *ESP in System PLC2 and current values stored at the addresses.

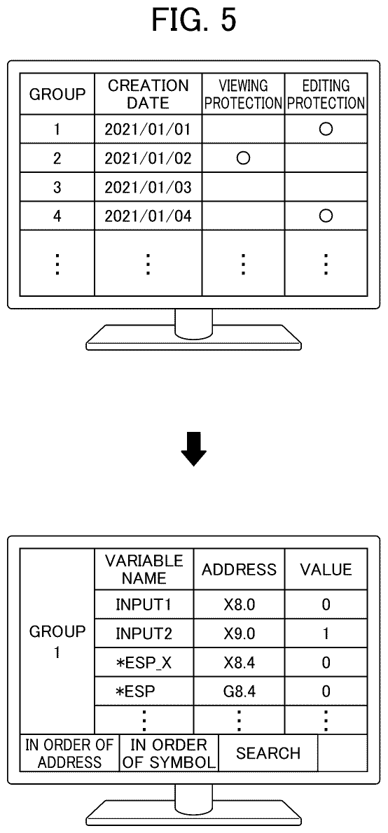

Further, the group management unit 103 can set, for each created group, display order of members included in the group or/and property information including a group creation date, variable names included in the group, addresses, whether viewing of current values stored at the addresses is allowed or not (also referred to as “viewing protection”) and whether editing of the current values stored in the variables included in the group is allowed or not (also referred to as “editing protection”). For example, as for the creation date, the viewing protection, and the editing protection, among the pieces of property information, the group creator may be able to set them. Further, as for the display order of members included in each group, a user who can view or edit the group may be able to set it at the time of displaying the group. FIG. 5 is an overview diagram showing an example of setting of whether viewing and editing of members included in each group are allowed or not, and of display order of the members. As shown in FIG. 5, the creation date of Group 1 is Jan. 1, 2021, and property information to which editing protection is applied (that is, editing of which is impossible) is given. Since viewing protection is not applied to Group 1, display order can be set at the time of viewing. As for Group 2, since viewing of viewing-protected property information is not allowed, editing is not allowed by default. Thereby, by setting, for each group, property information and display order of members included in the group, the user can manage the group and change display order of members according to the user's needs in displaying in a list.

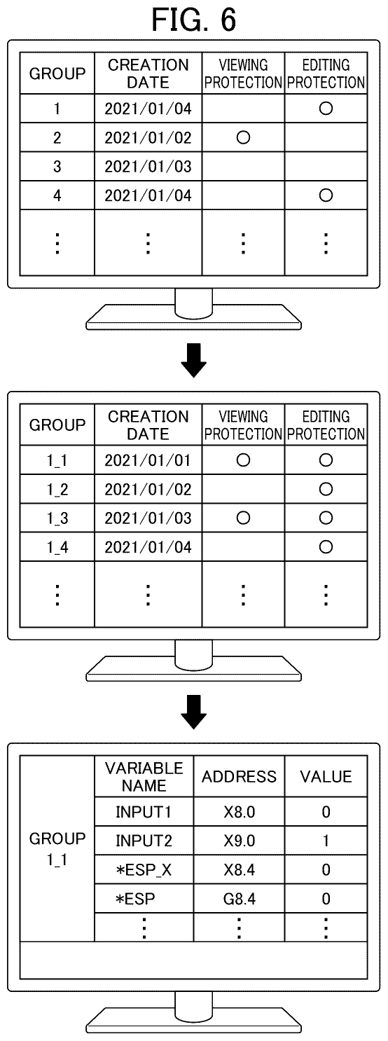

Further, based on pieces of correlation information indicating correlation relationships with a group, the group management unit 103 may create a group forming a hierarchical structure so that the group includes a plurality of subgroups. FIG. 6 is a diagram showing an example of subgroups included in a group. As shown in FIG. 6, Group 1_1 is Group 1 created on Jan. 1, 2021, which has been exemplified with reference to FIGS. 2, 4A, and 5. After that, the group management unit 103 creates Group 1_2 on Jan. 2, 2021, creates Group 1_3 on Jan. 3, 2021, and creates Group 1_4 on Jan. 4, 2021,which are in correlation relationships with Group 1_1, and creates Group 1 on Jan. 4, 2021 as a group that includes the above groups (a parent group). Thus, the group management unit 103 can create a plurality of groups in a hierarchical structure. Further, created groups may be edited to belong to a parent group in a hierarchical structure. Thus, for example, by causing members in correlation relationships with a group to be subgroups of the group, the user can improve his usability.

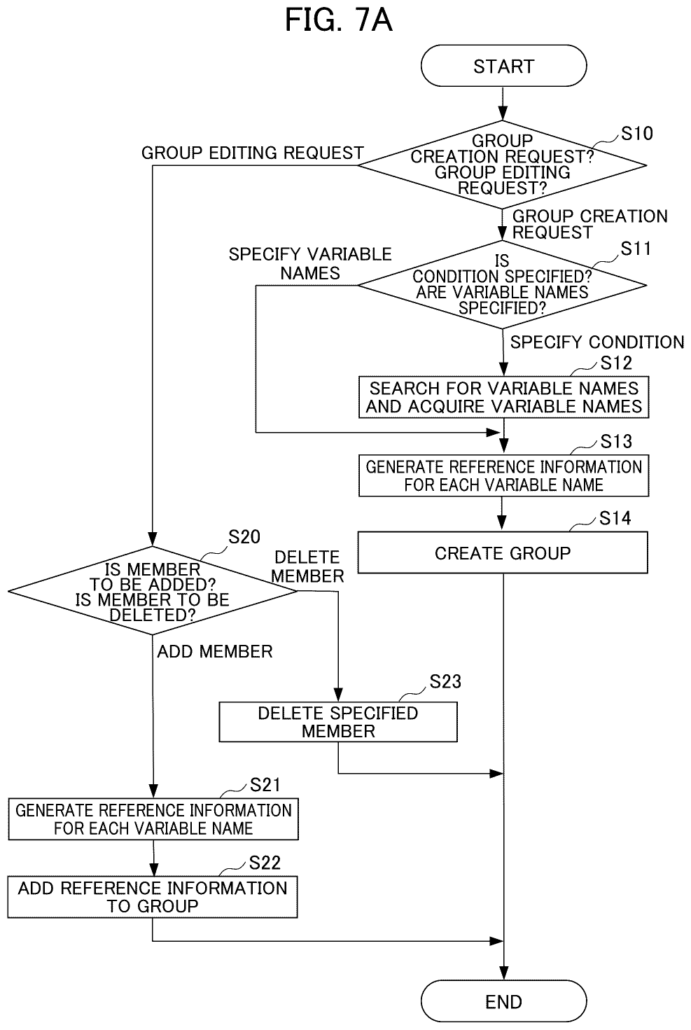

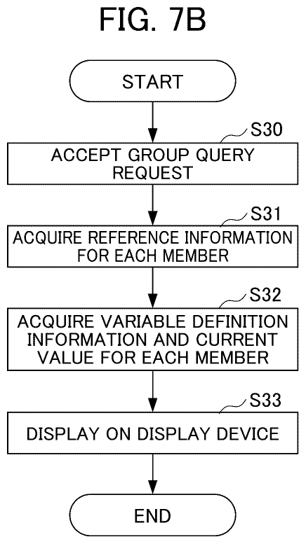

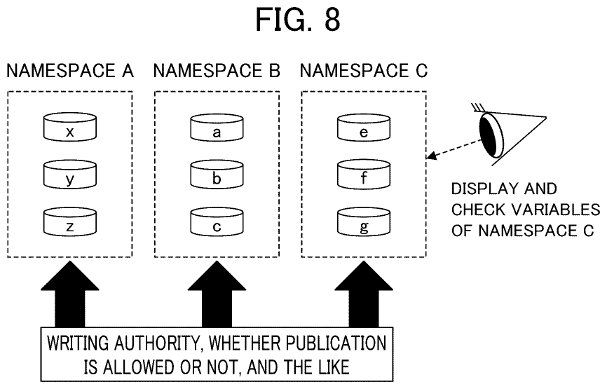

The query request acceptance unit 104 accepts a request to query an arbitrary group managed by the group management unit 103, from the user via the input unit 16. Thereby, in response to a group query request accepted by the query request acceptance unit 104, the group management unit 103 provides queried information about members included in the group requested to be queried, by acquiring pieces of variable definition information from the storage unit 22 and acquiring current values stored at addresses from the memory unit 202 based on pieces of reference information registered in the group requested to be queried. The functional units of the control apparatus 1 have been described above. Next, operations of the control apparatus 1 will be described. FIGS. 7A and 7B are flowcharts showing the operations of the control apparatus 1, respectively. FIG. 7A is a flowchart showing an operation at the time of creating or editing a group. FIG. 7B is a flowchart showing an operation at the time of displaying pieces of definition information about members (variables) included in a specified group and current values of the variables.

Referring to FIG. 7A, the group editing request acceptance unit 101 accepts a group creation or editing request at Step S10 and, in the case of a group creation request, proceeds to Step S11. In the case of an editing request, the group editing request acceptance unit 101 proceeds to Step S20.

At Step S11, the group editing request acceptance unit 101 accepts variable names or a condition for specifying grouping targets and, in the case of accepting variable names, proceeds to Step S13. In the case of accepting a condition, the group editing request acceptance unit 101 proceeds to Step S12.

At Step S12, for each specified system, the reference information generation unit 102 searches for all variable names that satisfy the condition and acquires all the variable names to be targeted by grouping. After that, the reference information generation unit 102 proceeds to Step S13.

At Step S13, the reference information generation unit 102 generates reference information for each of all the variable names to be targeted by grouping.

At Step S14, the group management unit 103 creates a new group based on members that include the generated pieces of reference information and ends the process.

At Step S20, if the editing request is to add variable names, the group management unit 103 proceeds to Step S21. If the editing request is to delete members belonging to the group, the group management unit 103 proceeds to Step S23.

At Step S21, the reference information generation unit 102 generates reference information for each of the specified variable names.

At Step S22, the group management unit 103 adds members that include the pieces of reference information generated at Step S21 to the specified group and ends the process.

At Step S23, the group management unit 103 deletes the specified members from the group and ends the process. A process flow showing the operation of the control apparatus 1 at the time of creating or editing a group has been described above. Next, description will be made on a process flow of the control apparatus 1 at the time of, in the case of accepting a group query request, displaying pieces of definition information about members (variables) included in the specified group and current values of the variables.

Referring to FIG. 7B, at Step S30, the query request acceptance unit 104 accepts a group query request.

At Step S31, the group management unit 103 acquires all pieces of reference information registered in the group requested to be queried at Step S30.

At Step S32, the group management unit 103 acquires pieces of variable definition information from the storage unit 22 and acquires current values stored at addresses from the memory unit 202, based on the pieces of reference information acquired at Step S31.

At Step S33, the group management unit 103 outputs pieces of queried information about members included in the group requested to be queried, for example, to the display device 17. The process flow showing the operation of the control apparatus 1 at the time of querying a group has been described above. The process flows showing the operations of the control apparatus 1 have been described.

One embodiment of the control apparatus 1 has been described above. The control apparatus 1, however, is not limited to the one embodiment described above and includes modifications, improvements, and the like within a range that the object can be achieved.

### Modification Example 1

Though the PLC apparatus 2 is communicably connected to the control apparatus 1 in the one embodiment described above, the present invention is not limited thereto. For example, the control apparatus 1 may include the PLC apparatus 2. Further, the PLC apparatus 2 may be provided with the functional units of the control apparatus 1, the input unit 16, and the display device 17.

Each function included in the control apparatus 1 in the one embodiment can be realized by hardware, software, or a combination thereof. Here, being realized by software means being realized by a computer reading and executing a program.

The program can be stored in any of various types of non-transitory computer-readable media and supplied to the computer. The non-transitory computer-readable media include various types of tangible storage media. Examples of the non-transitory computer-readable media include magnetic recording media (for example, a flexible disk, a magnetic tape, and a hard disk drive), magneto-optical recording media (for example, a magneto-optical disk), a CD-ROM (read-only memory), a CD-R, a CD-R/W, and semiconductor memories (for example, a mask ROM, a PROM (programmable ROM), an EPROM (erasable PROM), a flash ROM, and a RAM). The program may be supplied to the computer by any of various types of transitory computer-readable media. Examples of the transitory computer-readable media include an electrical signal, an optical signal and an electromagnetic wave. The transitory computer-readable media can supply the program to the computer via a wired communication path such as an electrical wire and an optical fiber, or a wireless communication path.

Steps describing the program recorded in a recording medium include not only processes that are performed in time series in the order thereof but also processes that are not necessarily performed in time series but are executed in parallel or individually.

In other words, a control apparatus of the present disclosure can take various kinds of embodiments having configurations as described below.

(1) A control apparatus 1 according to the present embodiment is a control apparatus 1 communicably connected to a PLC apparatus 2, the PLC apparatus 2 including a memory unit 202 in which addresses available on a PLC and data of current values at the addresses are recorded, and a storage unit 22 that manages a sequence program to be executed for each of namespaces and pieces of variable definition information related to variables defined for the addresses recorded in the memory unit 202, the pieces of variable definition information being for use in the sequence program for each of the namespaces. The control apparatus 1 includes a control unit 10 and an input unit 16. The control unit 10 includes: a group editing request acceptance unit 101 configured to receive, via the input unit 16, an input of arbitrary addresses recorded in the memory unit 202 or an input of arbitrary variables registered with the storage unit 22 for each of the namespaces, the group editing request acceptance unit 101 being configured to accept a request to create a group or a request to edit a group; a reference information generation unit 102 configured to generate pieces of reference information indicating where in the memory unit 202 or the storage unit 22 the addresses or the variables accepted by the group editing request acceptance unit 101 are recorded; a group management unit 103 configured to create a new group based on members including the pieces of reference information in a case of accepting the request to create a group by the group editing request acceptance unit 101, and, to additionally register members including the pieces of reference information into the group in a case of accepting the request to edit a group by the group editing request acceptance unit 101; and a query request acceptance unit 104 configured to accept, via the input unit 16, a request to query an arbitrary group managed by the group management unit 103. The group management unit 103 acquires, in response to the query request accepted by the query request acceptance unit 104, addresses and current values from the memory unit 202, and pieces of variable definition information from the storage unit 22, based on pieces of reference information registered in the group requested to be queried, and provides the addresses, the current values, and the pieces of variable definition information as queried information about members included in the group.

Thereby, it is possible to, for a program created over a plurality of namespaces, collectively check or diagnose states of arbitrary variables across the plurality of namespaces at the same time, by providing a mechanism for managing pieces of information for referring to variable definitions by group, over the plurality of namespaces without depending only on the namespaces. Therefore, it is possible to display only states of variables registered in the groups, and thus the display processing load can be reduced.

(2) In the control apparatus 1 according to (1), the namespaces may be expressed by either POU names or system names of the PLC apparatus 2.

Thereby, it is possible to, for a program created over a plurality of systems or POUs, collectively check or diagnose states of arbitrary variables across the plurality of systems or POUs at the same time, by providing a mechanism for managing pieces of information for referring to variable definitions by group, over the plurality of systems or POUs without depending only on the systems or POUs. Therefore, it is possible to display only states of variables registered in the groups, and thus the display processing load can be reduced.

(3) In the control apparatus 1 according to (1) or (2), the group management unit 103 may set, for the group, display order of the members included in the group or/and property information including a creation date of the group, whether viewing is allowed or not, and whether editing is allowed or not.

Thereby, by setting, for each group, property information and display order of members included in the group, it is possible to manage the group and change a list display form according to the user's needs.

(4) In the control apparatus 1 according to any of (1) to (3), the group management unit 103 may create a plurality of subgroups based on pieces of correlation information indicating correlation relationships with the groups.

Thereby, by further causing members in correlation relationships with a group to be subgroups of the group, it is possible to improve the user's usability.

(5) In the control apparatus 1 according to any of (1) to (4), the reference information generation unit 102 may generate pieces of reference information for variables satisfying a condition specified via the input unit 16 and generate a group satisfying the condition based on the generated pieces of reference information.

Thereby, when desiring to collectively check or diagnose variables satisfying a certain condition, the user can easily check or diagnose the variables by generating a group configured with the variables satisfying the condition simply by inputting the condition.

(6) The control apparatus 1 according to any of (1) to (5) may include the PLC apparatus 2.

(7) The control apparatus 1 according to any of (1) to (5) may be included in the PLC apparatus 2.

### EXPLANATION OF REFERENCE NUMERALS

1 CONTROL APPARATUS
10 CONTROL UNIT
101 GROUP EDITING REQUEST ACCEPTANCE UNIT
102 REFERENCE INFORMATION GENERATION UNIT
103 GROUP MANAGEMENT UNIT
104 QUERY REQUEST ACCEPTANCE UNIT
12 STORAGE UNIT
16 INPUT UNIT
17 DISPLAY DEVICE
2 PLC APPARATUS
20 PLC_CPU
202 MEMORY UNIT
22 STORAGE UNIT

1. A control apparatus communicably connected to a PLC apparatus, the PLC apparatus comprising:
a memory unit in which addresses available on a PLC and data of current values at the addresses are recorded, and
a storage unit that manages a sequence program to be executed for each of namespaces and pieces of variable definition information related to variables defined for the addresses recorded in the memory unit, the pieces of variable definition information being for use in the sequence program for each of the namespaces,
the control apparatus comprising:
a control unit; and
an input unit, wherein
the control unit comprises:
a group editing request acceptance unit configured to receive, via the input unit, an input of arbitrary addresses recorded in the memory unit or an input of arbitrary variables registered with the storage unit for each of the namespaces, the group editing request acceptance unit being configured to accept a request to create a group or a request to edit a group;
a reference information generation unit configured to generate pieces of reference information indicating where in the memory unit or the storage unit the addresses or the variables accepted by the group editing request acceptance unit are recorded;
a group management unit configured to create a new group based on members including the pieces of reference information in a case of accepting the request to create a group by the group editing request acceptance unit, and to additionally register members including the pieces of reference information into the group in a case of accepting the request to edit a group by the group editing request acceptance unit; and
a query request acceptance unit configured to accept, via the input unit, a request to query an arbitrary group managed by the group management unit, and
the group management unit acquires, in response to the query request accepted by the query request acceptance unit, addresses and current values from the memory unit, and pieces of variable definition information from the storage unit, based on pieces of reference information registered in the group requested to be queried, and provides the addresses, the current values, and the pieces of variable definition information as queried information about members included in the group.

2. The control apparatus according to claim 1, wherein
the namespaces are expressed by either POU names or system names of the PLC apparatus.

3. The control apparatus according to claim 1, wherein
the group management unit sets, for the group, display order of the members included in the group or/and property information including a creation date of the group, whether viewing is allowed or not, and whether editing is allowed or not.

4. The control apparatus according to claim 1, wherein the group management unit creates a plurality of subgroups based on pieces of correlation information indicating correlation relationships with the group.

5. The control apparatus according to claim 1, wherein
the reference information generation unit generates pieces of reference information for variables satisfying a condition specified via the input unit and generates a group satisfying the condition based on the generated pieces of reference information.

6. The control apparatus according to claim 1, comprising the PLC apparatus.

7. The control apparatus according to claim 1, wherein the control apparatus is included in the PLC apparatus.
